(19) United States
(12) Patent Application Publication
(10) Pub. No.: US 2016/0165847 A1
(43) Pub. Date: Jun. 16, 2016

(54) ANIMAL EXCREMENT RECEIVING DEVICE

(71) Applicant: Cheng-Wei HUANG, Tainan City (TW)

(72) Inventor: Cheng-Wei HUANG, Tainan City (TW)

(21) Appl. No.: 14/569,364

(22) Filed: Dec. 12, 2014

(51) Int. Cl. A01K 23/00

(52) U.S. Cl. CPC A01K 23/005

(57) ABSTRACT

An animal excrement receiving device, comprising a body having a receiving member, and a long binding strip. The receiving member includes a receiving space, an inner side and an outer side. The binding strip is for surrounding the outer side of the receiving member, and includes two end portions and an elastic portion between the two end portions. The end portions are for connecting to the body, and at least one of the end portions is detachable. By applying a single-point force on the detachable end portion, the detachable end portion is controlled to connect to the body to deform the elastic portion, such that the binding strip generates a clamping force towards the receiving member. Alternatively, the detachable end portion is controlled to disengage from the body to restore the elastic portion to eliminate the clamping force from the binding strip.

### BACKGROUND OF THE INVENTION

a) Field of the Invention

The invention relates in general to an animal excrement receiving device, and more particularly, to a receiving device that secures secured by a long single-handedly operable binding strip.

b) Description of the Prior Art

To facilitate the process and convenience for cleaning pet excrement, pet owners may apply “Catch Device (IV)” as disclosed by the Taiwan Patent No. M396001. The catch device (IV) includes a rod, a receiving element, a cover, a screw, a screw nut, and washers, and may be tightly disposed at a front end of the rod via elements including the cover, the screw, the screw nut, and the left and right washers. In the receiving element, two hanging ear portions are extended towards a rear direction for placing hanging holes of a plastic bag.

However, the above prior art can only be applied to a bag additionally provided with hanging holes in order to secure the bag to the catch device. That is, the receiving element cannot be applied to a bag without hanging holes, leading to unsatisfactory ease of use.

There are manufacturers that develop other known technologies such as the Taiwan Patent Publication No. 371831 disclosing “Pet Excrement Cleaner” and the U.S. Pat. No. 3,937,509 disclosing “Animal Feces Collecting Device”. A structure of the above disclosures mainly includes a receiving element and a binding loop. The receiving element is defined with a receiving space for a bag to be placed therein. An opening of the bag is affixed to the receiving element by the binding loop while leaving the opening of the bag open, so as to facilitate a user to align the opening of the bag with an excretory part of a pet to receive animal excrement. Further, the above receiving element can be applied to bags with or without hanging holes.

The Taiwan Patent Publication No. M482949 discloses “Dog Feces Receiving Device”, which includes a frame, a bag and a rod. The frame may be accommodated and tightened by an elastic loop binding strip for securing the bag to the frame. As such, a user is allowed to hold the rod to receive dog feces by the bag.

The Taiwan Patent Publication No. M303623 discloses “Pet Excrement Collecting Device”, which includes a two-stage holding rod, a liftable frame and a collecting bag. An opening of the collecting bag is provided with an elastic binding region for accommodating and securing the collecting bag at the liftable frame, so as to receive pet excrement.

However, the above disclosures of the prior art suffer from certain drawbacks due to the reasons below.

1. In the disclosures of the Taiwan Patent Publication No. 371831 and the U.S. Pat. No. 3,937,509, the processes of accommodating and placing or removing the binding loop is inconvenient. The elastic binding loop is a closed ring, and can only be steadily stretched by operating the binding loop with both hands in order to place the binding loop to or remove the binding loop from the receiving element. Similarly, in the disclosures of the Taiwan Patent Publication Nos. M482949 and M303623, the elastic binding strip and the binding region of the collecting bag face the same issue.

2. After using the binding loop, the elastic binding strip or binding region of the collecting bag for a certain period of time, insufficient clamping forces may not be provided due to elasticity fatigue, thus degrading product practicability.

3. To allow a user to clean feces without squatting down in great effort, a cleaner usually is connected with a long holding rod (e.g., the above U.S. Pat. No. 3,937,509). However, the holding rod and the receiving element cannot be tightly adhered to each other when collapsed. As such, more space is consumed for storing the cleaner.

### SUMMARY OF THE INVENTION

In view of the insufficient convenience of a conventional receiving device, the present invention provides an animal excrement receiving device. The animal excrement receiving device of the present invention includes a body and a binding strip. The body includes a receiving member. The receiving member is defined with a receiving space, and has an inner side adjacent to the receiving space and an outer side opposite the inner side. The binding strip, being a long strip adapted to surround the outer side of the receiving member, includes two end portions and an elastic portion located between the two end portions. The end portions are for connecting to the body, and at least one of the end portions is detachable. By applying a single-point force at the detachable end portion, the detachable end portion is controlled to connect to the body to deform the elastic portion, such that the binding strip generates a clamping force towards the receiving member. Alternative, by applying a single-point force at the detachable end portion, the detachable end portion is controlled to disengage from the body to restore the elastic portion, so that the clamping force is eliminated from the binding strip.

Further, the outer side of the receiving member is provided with a first block flange, and a height position of the binding strip is lower than the first block flange.

Further, the outer side of the receiving member is provided with a second block flange, an accommodating groove is defined between the first block flange and the second block flange, and the binding strip is located in the accommodating groove.

Further, the outer side of the receiving member is provided with two first fastening portions, and each of the two end portions of the binding strip is provided with a second fastening portion for corresponding to the fastening portions. For example, each of the first fastening portions is a fastening hole, and each of the second fastening portions is a hook portion corresponding to the fastening hole.

Further, the body includes an adjustment fastening portion. The second fastening portions of the binding strip have a first stretch length corresponding to the first fastening portions, and a second stretch length corresponding to the adjustment fastening portion. The second stretch length is greater than the first stretch length. For example, each of the first fastening portions is a fastening hole, and each of the second fastening portions is a hook portion corresponding to the fastening hole.

Further, the receiving member includes a block portion, and the body further includes a holding member pivotally connected to the receiving member. When the receiving member is pivotally rotated relative to the receiving member to an application position, the holding member is abutted on the block portion to secure the receiving member at the application position.

Further, the receiving member includes two opposite brackets, a first accommodating opening between the two opposite brackets, a second accommodating opening, and the receiving space located between the first accommodating opening and the second accommodating opening. The second accommodating opening is adjacent to the block portion, such that when the holding member is pivotally rotated relative to the receiving member to a collapsed position, the holding member is disengaged from the block portion, and is correspondingly stored into the first accommodating opening, the second accommodating opening and the receiving space of the receiving member.

The present invention provides following effects.

1. In the present invention, the binding strip for binding the bag is a long binding strip, and one of the binding strips connects to the receiving member in a “detachable” manner. Thus, a user is allowed to single-handedly place the binding strip around or disengage the binding strip from the receiving member to provide better ease of use and convenience.

2. The present invention is provided with the adjustment fastening portion, which allows the stretch length of the binding strip to be adjusted when the binding strip suffers from elasticity fatigue or insufficient elasticity. As such, the bag is provided with a sufficient clamping force to further enhance product practicability.

3. In the present invention, the two ends of the receiving space of the receiving member are provided with accommodating openings. When the holding member is pivotally rotated relative to the receiving member to a collapsed position, the holding member may be correspondingly stored in the first accommodating opening, the second accommodating opening and the receiving space of the receiving member, thereby reducing the space occupied by the receiving member and enhancing product storage convenience.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a three-dimensional exploded view according to a first embodiment of the present invention;

FIG. 2 is a schematic view of a three-dimensional appearance according to the first embodiment of the present invention;

FIG. 3 is a schematic diagram of directions for applying a device with a bag according to the first embodiment of the present invention;

FIG. 4 is a first schematic diagram of operations of a binding strip binding a bag according to the first embodiment of the present invention;

FIG. 5 is a second schematic diagram of operations of a binding strip binding a bag according to the first embodiment of the present invention;

FIG. 6 is a front sectional view of a binding strip binding a bag according to the first embodiment of the present invention;

FIG. 7 is a schematic view of a state of a binding strip binding a bag according to the first embodiment of the present invention;

FIG. 8 is a schematic diagram of a usage state according to the first embodiment of the present invention;

FIG. 9 is a schematic diagram of a relative collapsed state of a receiving member and a holding member according to the first embodiment of the present invention;

FIG. 10 is a top sectional view according to a second embodiment of the present invention; and

FIG. 11 is a schematic diagram of a three-dimensional appearance according to a third embodiment of the present invention.

### DETAILED DESCRIPTION OF THE PREFERRED EMBODIMENTS

The above and other aspects of the invention will become better understood with regard to the following detailed description of the preferred but non-limiting embodiments. The following description is made with reference to the accompanying drawings.

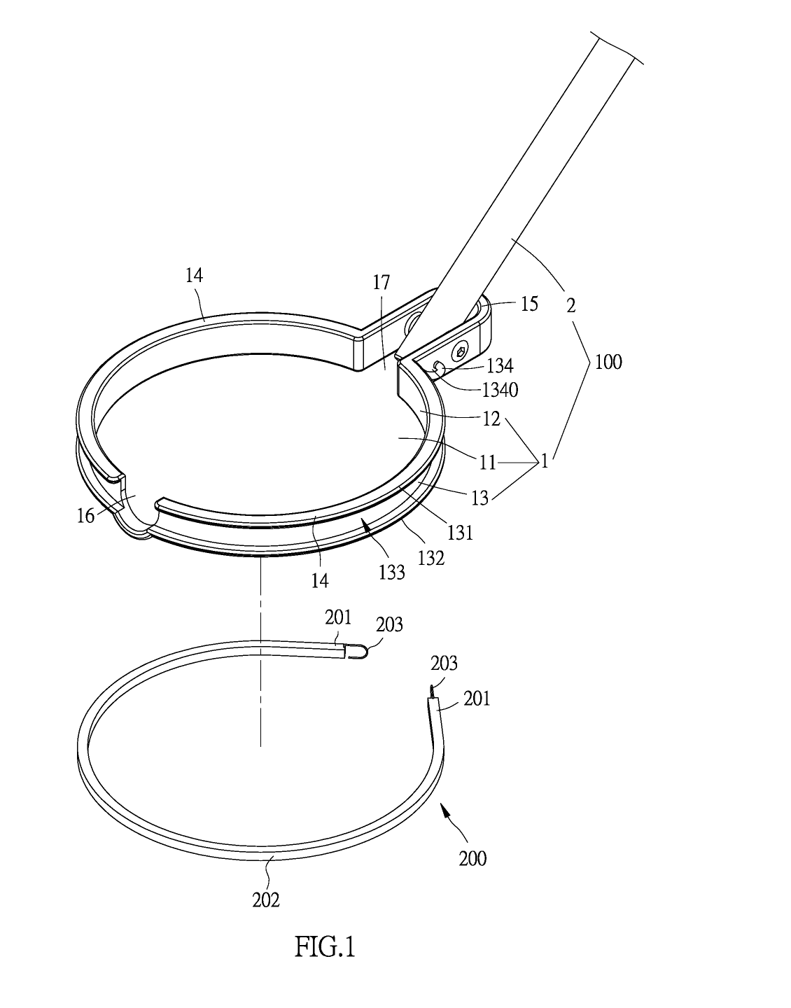

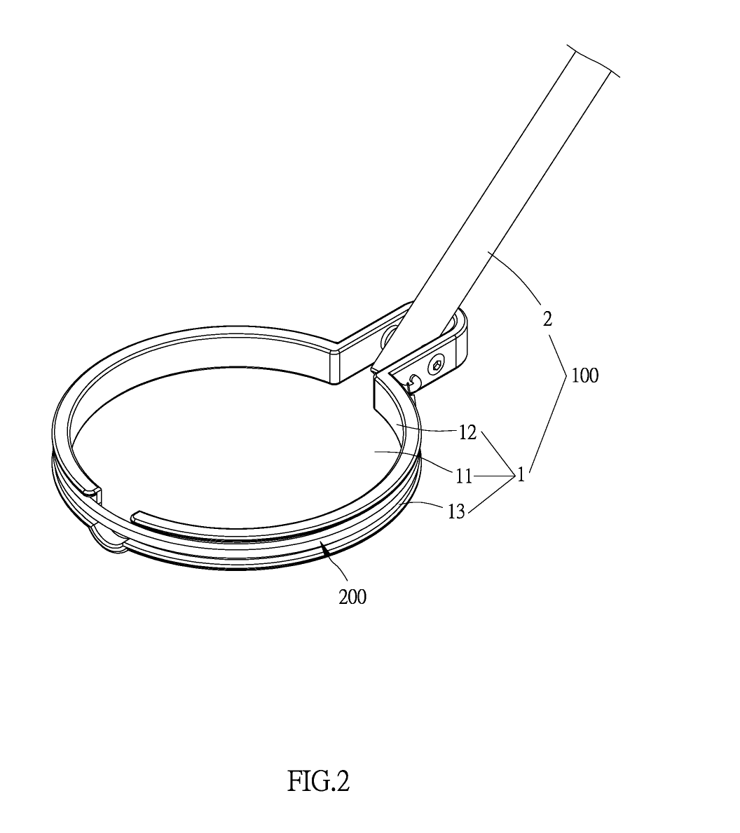

FIG. 1 and FIG. 2 are a three-dimensional exploded view and a three-dimensional appearance diagram of an animal excrement receiving device according to a first embodiment of the present invention, respectively. Referring to FIG. 1 and FIG. 2, the animal excrement receiving device according to the first embodiment includes a body 100, and a long binding strip 200.

The body 100 includes a receiving member 1 and a holding member 2. The receiving member 1 is defined with a receiving space 11, and has an inner side 12 adjacent to the receiving space 11 and an outer side 13 opposite the inner side 12. The outer side 13 of the receiving member 1 is provided with a first block flange 131, a second block flange 132 corresponding to the first block flange 131, and an accommodating groove 133 defined between the first block flange 131 and the second block flange 132. The outer side 13 of the receiving member 1 is further provided with two first fastening portions 134 at positions corresponding to the accommodating groove 133. In the embodiment, for example, the first fastening portions 134 are disposed on the receiving member 1. In another embodiment, given that the binding strip 200 can be accordingly secured, the first fastening portions 134 may also be disposed on the holding member 2.

The receiving member 1 further includes two opposite brackets 14, and a block portion 15 connected to the brackets 14. Further, the receiving member 1 is defined with a first accommodating opening 16 between the brackets 14 and the block portion 15, a second accommodating opening 17, and the receiving space 11. The receiving space 11 is located between the first accommodating opening 16 and the second accommodating opening 17, and the second accommodating opening 17 is adjacent to the block portion 15.

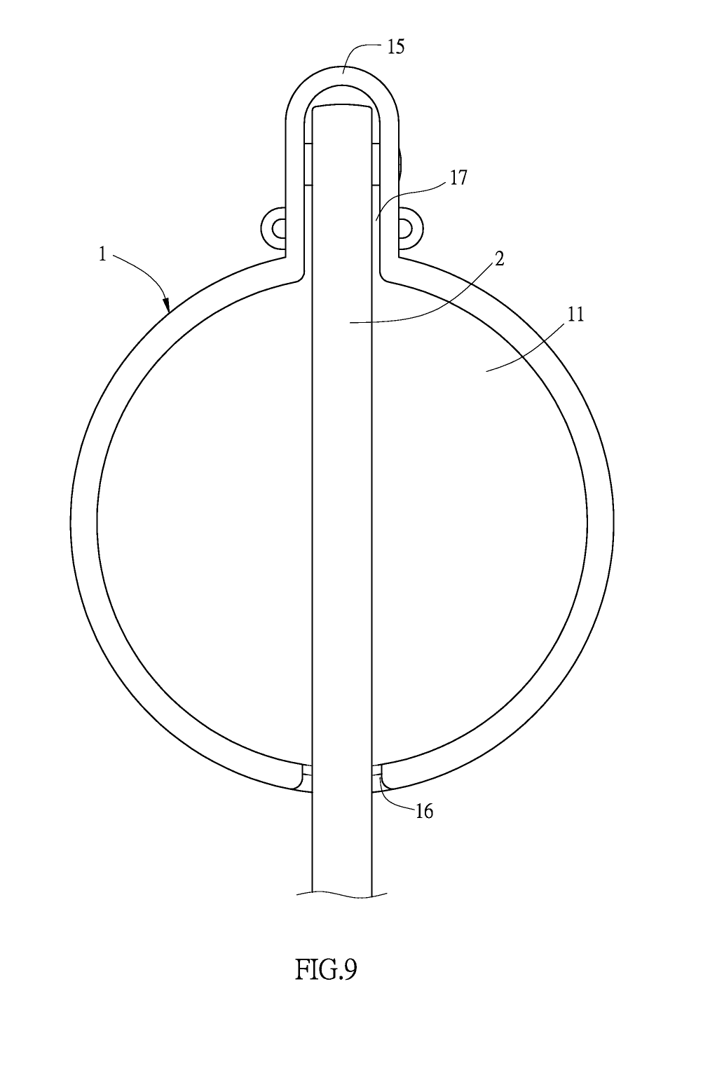

The holding member 2 is pivotally connected to the receiving member 1. When the receiving member 1 is pivotally rotated relative to the receiving member 1 to an application position (as shown in FIG. 1) or a collapsed position (as shown in FIG. 9), the holding member 2 is abutted on the block portion 15 of the receiving member 1 to secure the receiving member 1 at the application position. At the collapsed position (referring to FIG. 9), the holding member 2 is disengaged from the block portion 15 of the receiving member 1, and is correspondingly stored in the first accommodating opening 16, the second accommodating opening 17 and the receiving space 11 of the receiving member 1, thereby reducing the space occupied by the receiving device and enhancing product storage convenience.

The long binding strip 200, adapted to be surrounded at the outer side 13 of the receiving member 1, includes two end portions 201 and an elastic portion 202 located between the two end portions 201. The end portions 201 are for connecting to the body 100. A height position of the binding strip 200 is lower than the first block flange 131. In the embodiment, the binding strip 200 is an elastic strip, and the elastic portion 202, for example, is an integral connected to the end portions 201. In an alternative embodiment, the elastic portion 202 may also be a spring.

In the embodiment, for example, each of the two end portions 201 of the binding strip 200 is provided with a hook-shaped second fastening portion 203 for corresponding to a fastening hole 1340 of each of the first fastening portion 134 of the receiving member 1. Provided that the object of allowing at least one of the end portions 201 of the binding strip 200 to detachably combine to the body 100 is achieved, the second fastening portions 203 may also be disposed as fastening holes, and the first fastening portions 134 of the receiving member 1 are corresponding fastening portions.

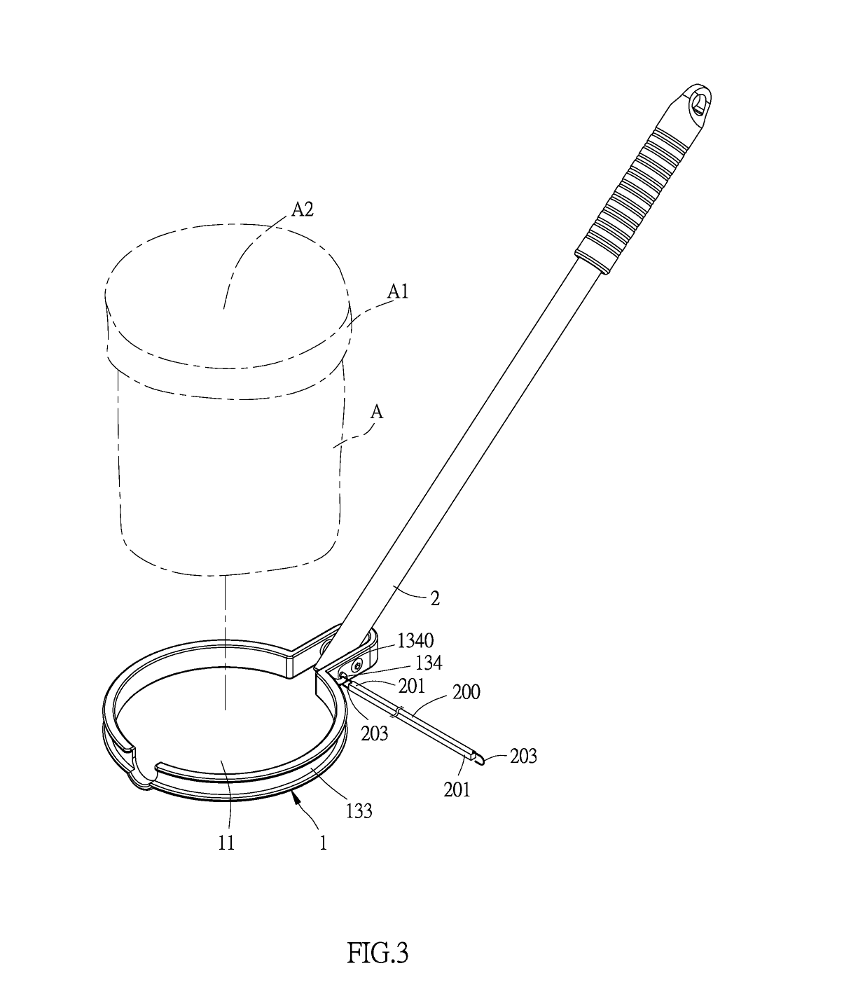

Referring to FIG. 3 for directions for applying the present invention, a user first spreads an opening edge A1 of a bag A onto the receiving member 1, such that an accommodating space A2 of the bag A is corresponded to the receiving space 11 of the receiving member 1. Further, the second fastening portion 203 of one of the end portions 201 of the binding strip 200 is fastened to the fastening hole 1340 of one of the first fastening portions 134 of the receiving member 1.

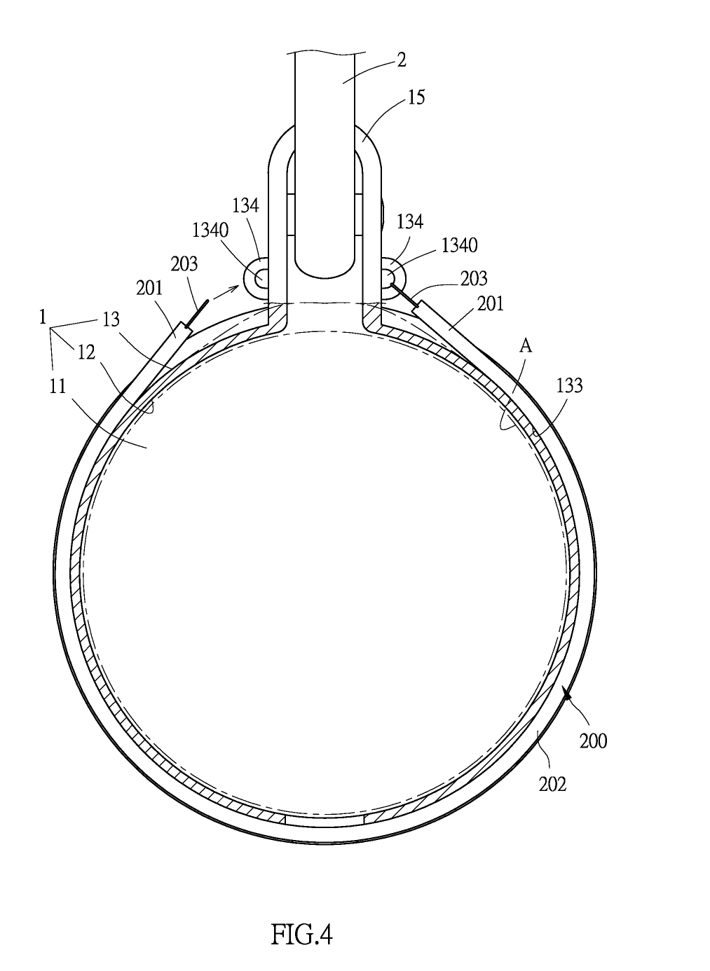

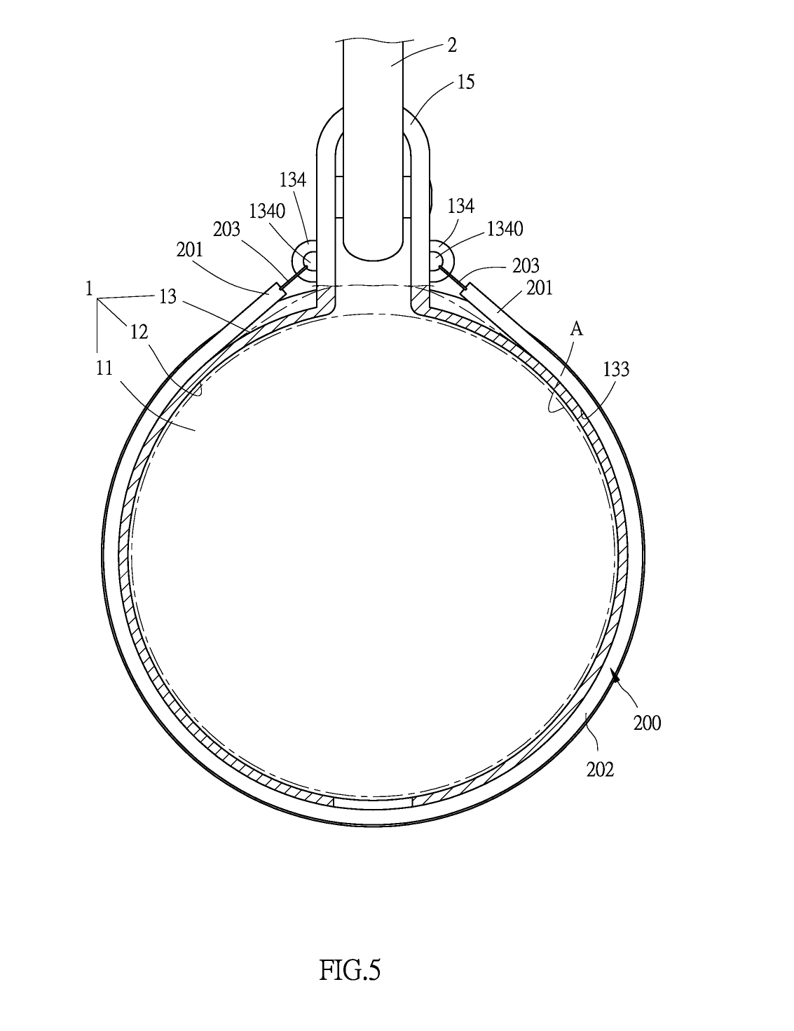

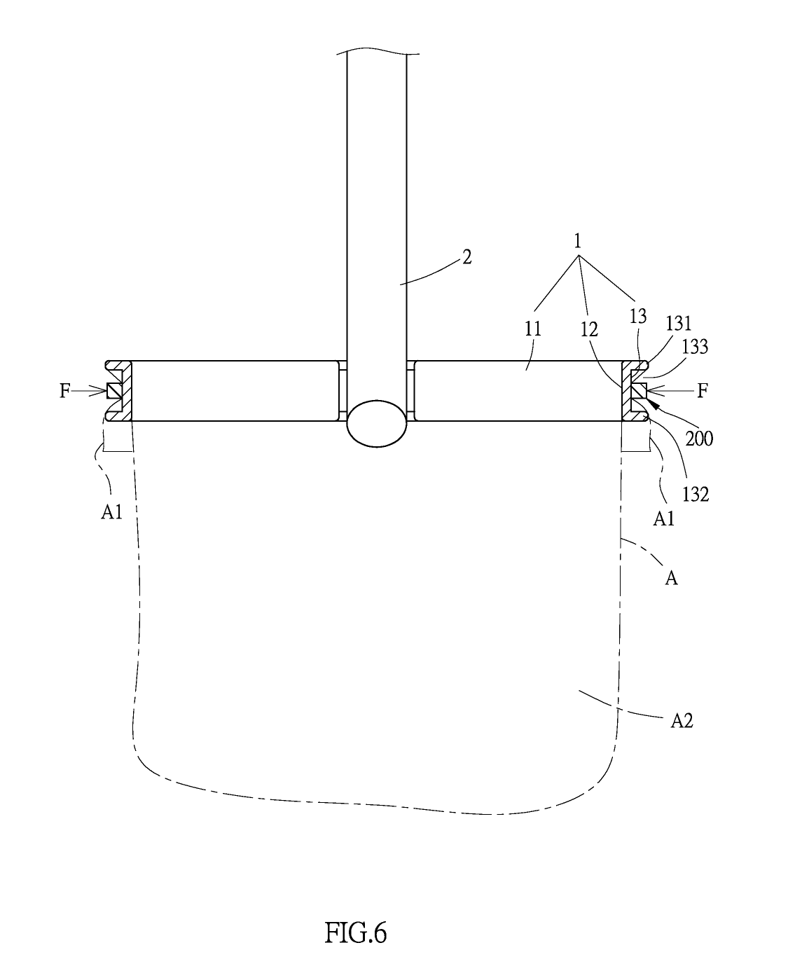

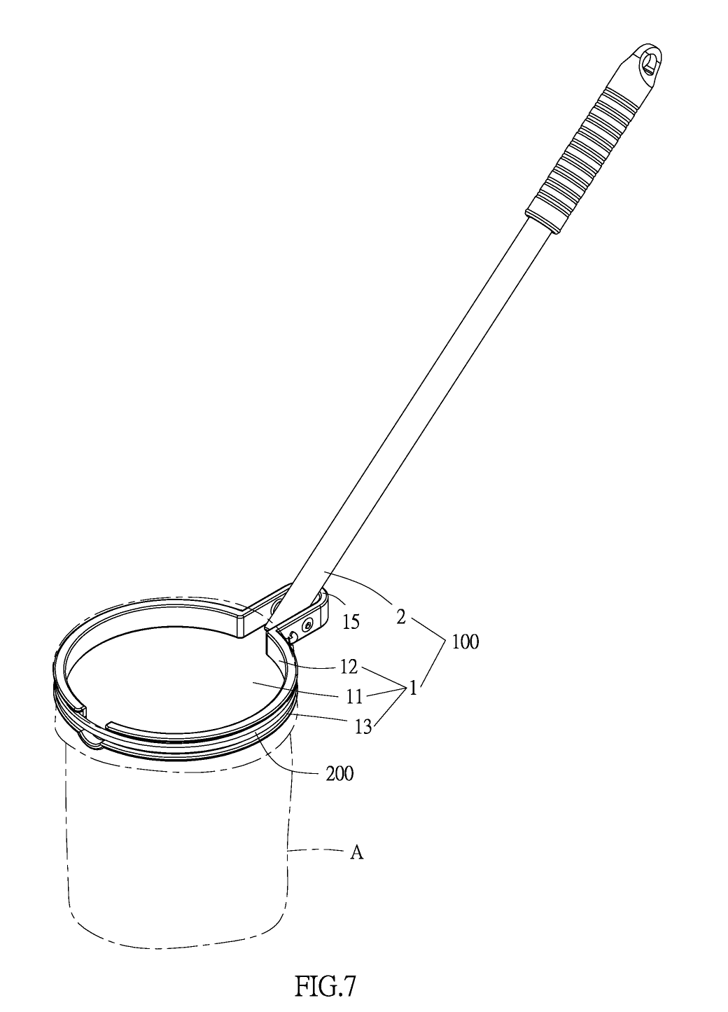

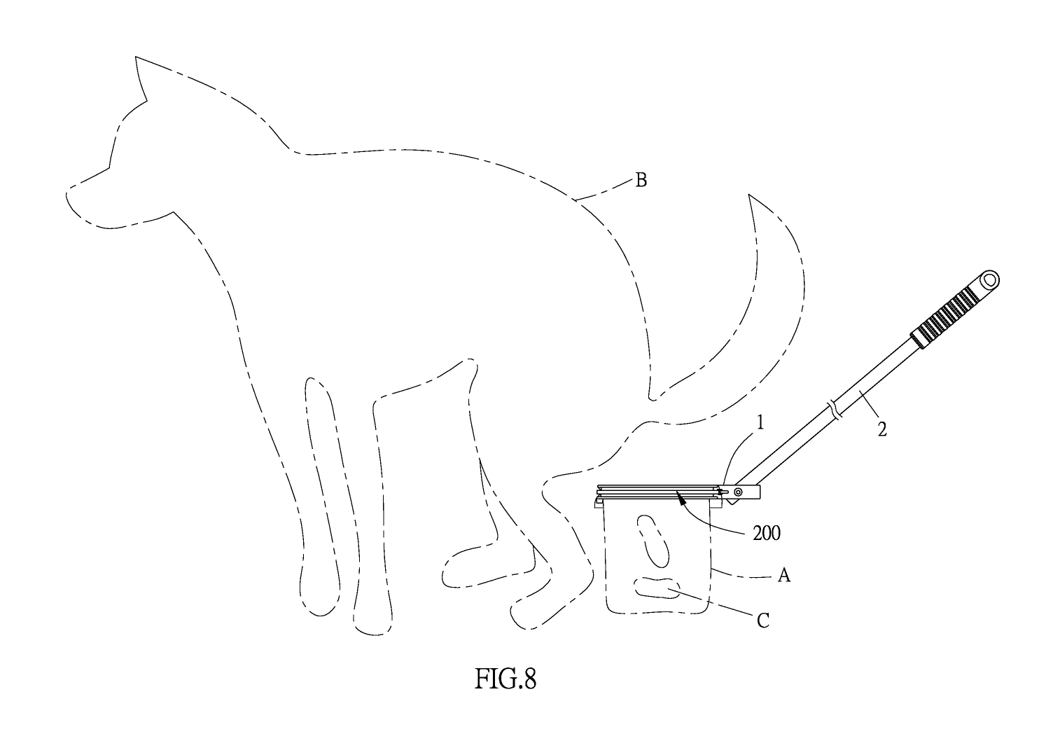

Referring to FIG. 4 and FIG. 5, the binding strip 200 is surrounded at the outer side 13 of the receiving member 1 along the accommodating groove 133, and the binding strip 200 is pulled and stretched to allow the other second fastening portion 203 to be fastened to the fastening hole 1340 of the other first fastening portion 134 of the receiving member 1. As such, the elastic portion 202 is caused to deform, in a way that the binding strip 200 generates a clamping force F towards the receiving member 1 (referring to FIG. 6). The clamping force F towards the receiving member 1 allows the binding strip 200 to bind the opening edge A1 of the bag A, thereby achieving the object of securing the bag A to facilitate a user to receive excrement C of an animal B (referring to FIG. 7 and FIG. 8).

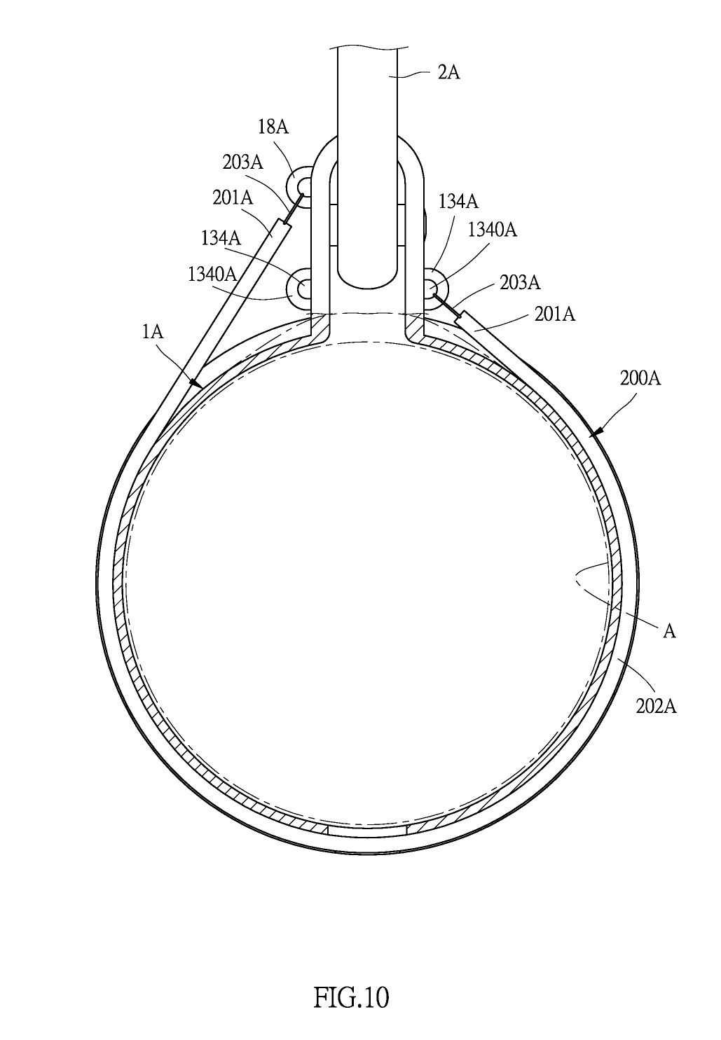

As shown in FIG. 10 showing a second embodiment of the present invention, differences of the embodiment in FIG. 2 from that in FIG. 1 are that, a receiving member 1A is provided with an adjustment fastening portion 18A, and the binding strip 200A has a first stretch length when two second fastening portions 203A at end portions 201A both correspond to fastening holes 1340A of first fastening portions 134A. When one of the second fastening portions 203A of the binding strip 200A is correspondingly fastened to the adjustment fastening portion 18A, the binding strip 200A has a second stretch length, which is greater than the first stretch length. Accordingly, when the elastic portion 202A suffers from elasticity fatigue or insufficient elasticity, the binding strip 200A is enabled to provide a sufficient clamping force through adjusting the stretch length of the binding strip 200A using the adjustment fastening portion 18A, thereby providing the bag A with a sufficient clamping force and further enhancing product practicability.

Instead of being in a quantity of one, the adjustment fastening portion 18A may also be provided in plural to provide the binding strip 200A with a multi-stage adjustment and fastening function. Further, instead of disposing the adjustment fastening portion 18A on the receiving member 1A as in this embodiment, the adjustment fastening portion 18A may also be disposed on the holding member 2A. The different approaches above aim at providing the binding strip 200A with securing positions of different distances to achieve the object of adjusting the stretch length.

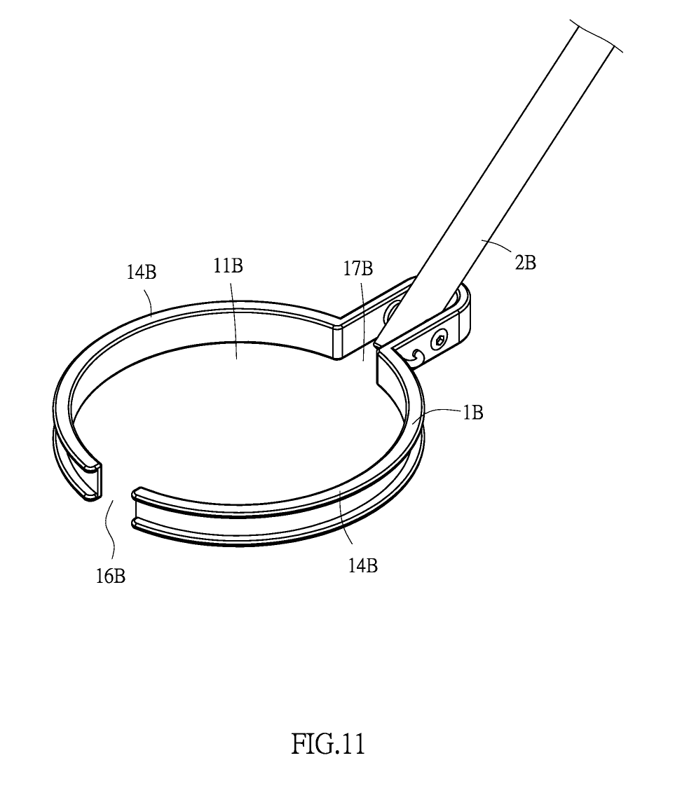

FIG. 11 shows a third embodiment of the present invention. Referring to FIG. 11, main differences of the embodiment in FIG. 11 from the first embodiment are that, a receiving member 1B is a non-closed loop, and a first accommodating opening 16B between two brackets 14B is penetrated through the receiving member 1B instead of being a recess form as in the first embodiment. Further, the first accommodating opening 16B is in communication with a receiving space 11B and a second accommodating opening 17B, so as to allow a holding member 2B to be pivotally rotated to and used at the other side of the receiving member 1B.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An animal excrement receiving device, comprising:
a body, having a receiving member, the receiving member being defined with a receiving space and provided with an inner side adjacent to the receiving space, an outer side opposite to the inner side and two first fastening portions provided on the outer side;
a binding strip, in form of long strip, adapted to surround at the outer side of the receiving member, having two end portions and an elastic portion between the two end portions, the end portions are connected to the body, each of the two end portions being provided with a second fastening portion for corresponding to the first fastening portions, the second fastening portion of at least one of the end portions being detachable from the corresponding first fastening portion of the body;
wherein, by applying a single-point force to the detachable end portion, the second fastening portion of the detachable end portion is controlled to connect to the first fastening portion of the body to deform the elastic portion, such that binding strip generates a clamping force towards the receiving member, or the second fastening portion of the detachable end portion is controlled to disengage from the first fastening portion of the body to restore the elastic portion to eliminate the clamping force from the binding strip.

2. The animal excrement receiving device according to claim 1, wherein the outer side of the receiving member is provided with a first block flange, and a height position of the binding strip is lower than the first block flange.

3. The animal excrement receiving device according to claim 2, wherein the outer side of the receiving member is provided with a second block flange corresponding to the first block flange, an accommodating groove is defined between the first block flange and the second block flange, and the binding strip is located in the accommodating groove.

4. The animal excrement receiving device according to claim 3, wherein the two first fastening portions are provided at positions corresponding to the accommodating groove.

5. The animal excrement receiving device according to claim 1, wherein each of the first fastening portions is a fastening hole, and each of the second fastening portions is a hook portion corresponding to the fastening hole.

6. The animal excrement receiving device according to claim 1, wherein the body is provided with a first fastening portion, and at least one of the end portions of the binding strip is provided with a second fastening portion for corresponding to the first fastening portion.

7. The animal excrement receiving device according to claim 1, wherein the body is provided with an adjustment fastening portion, the second fastening portion of the binding strip has a first stretch length corresponding to the first fastening portion, the second fastening portion of the binding strip has a second stretch length corresponding to the adjustment fastening portion, and the second stretch length is different from the first stretch length.

8. The animal excrement receiving device according to claim 6, wherein the body is provided with an adjustment fastening portion, the second fastening portion of the binding strip has a first stretch length corresponding to the first fastening portion, the second fastening portion of the binding strip has a second stretch length corresponding to the adjustment fastening portion, and the second stretch length is different from the first stretch length.

9. The animal excrement receiving device according to claim 7, wherein the first fastening portion is a fastening hole, and the second fastening portion is a hook portion corresponding to the fastening hole.

10. The animal excrement receiving device according to claim 8, wherein the first fastening portion is a fastening hole, and the second fastening portion is a hook portion corresponding to the fastening hole.

11. The animal excrement receiving device according to claim 1, wherein the receiving member comprises a block portion, and the body further provided with a holding member pivotally connected to the receiving member; when the holding member is pivotally rotated relative to the receiving member to an application position, the holding member is abutted on the block portion so that the receiving member is secured at the application position.

12. The animal excrement receiving device according to claim 11, wherein the receiving member is provided with two opposite brackets, a first accommodating opening between the two opposite brackets, a second accommodating opening, and the receiving space located between the first accommodating opening and the second accommodating opening, and the second accommodating opening is adjacent to the block member, such that when the holding member is pivotally rotated relative to the receiving member to a collapsed position, the holding member is disengaged from the block portion, and is correspondingly stored into the first accommodating opening, the second accommodating opening and the receiving space of the receiving member.
